(19) United States
(12) Patent Application Publication
(10) Pub. No.: US 2021/0136432 A1
(43) Pub. Date: May 6, 2021

(54) METHOD FOR RECHARGING LIVE STREAMING ACCOUNT, TERMINAL, AND STORAGE MEDIUM

(71) Applicant: HONG KONG LIVEME CORPORATION LIMITED, Hong kong (CN)

(72) Inventors: Chao XIAO, Beijing (CN); Xiliang BAI, Beijing (CN)

(21) Appl. No.: 16/473,733

(22) PCT Filed: Nov. 3, 2017
(86) PCT No.: PCT/CN2017/109355

§ 371 Date: Jun. 26, 2019

(30) Foreign Application Priority Data
Dec. 28, 2016 (CN) 201611236139.1

(51) Int. Cl. H04N 21/2543; H04N 21/258; G06Q 20/14; G06Q 20/40

(52) U.S. Cl. CPC H04N 21/2543; H04N 21/25866; G06Q 20/407; G06Q 20/4037; G06Q 20/14

(57) ABSTRACT

A method for recharging a live streaming account, a terminal, and a storage medium are provided. The method may include: receiving a recharging request sent by a first user, in which the recharging request includes a user identifier and a recharging amount; determining, according to the user identifier, a credit limit corresponding to the first user currently; judging whether the recharging amount is within a range corresponding to the credit limit; when the recharging amount is within the range corresponding to the credit limit, recharging, according to the recharging amount, an account corresponding to the user identifier.

### CROSS-REFERENCE TO RELATED APPLICATIONS

This application is a US national phase application of International Application No. PCT/CN2017/109355, filed on Nov. 3, 2017, which claims priority to and benefits of Chinese Patent Application Serial No. 201611236139.1, filed with the State Intellectual Property Office of P. R. China on Dec. 28, 2016 by LIVE.ME INC., entitled “live streaming account recharging method, device, and terminal”, the entire content of which is incorporated herein by reference.

### FIELD

The present disclosure relates to mobile Internet technology field, and more particularly, to a method for recharging a live streaming account, a terminal, and a storage medium.

### BACKGROUND

With the improvement of network speed and the development of computer technology, the live streaming video has gradually become a new hot spot of people's social entertainment. Existing network live streaming videos generally include games, anchors' individual shows and live public scenes, and the like. For example, an anchor may use a mobile phone or a PC camera to show his/her talents to the public, other users may watch the anchor's individual show synchronously through the live streaming video, and interact with the anchor by leaving comments and sending gifts.

In prior art, a user may recharge to a live streaming platform, and then buy virtual gifts for the anchor. The anchor may also make profits by withdrawing deposit from the live streaming platform.

However, a target live streaming platform allows the user to apply for a refund after recharging, which may cause some problems, including that after an anchor withdraws cash, the live streaming platform still needs to refund the money to the user; some users perform a maliciously recharging and then cancelling the recharging; or some users use the live streaming platform to launder money or cash out. It will greatly increase the costs and risks of the live broadcast platform.

### SUMMARY

Embodiments of the present disclosure aim to solve at least one of the technical solutions in the related art.

To this end, embodiments of the present disclosure provide a method for recharging a live streaming account, which may realize a determination of a credit limit of a user according to attribute information of the user so as to perform the recharging for the user. In addition, the credit limit of the user may be adjusted dynamically, thereby reducing a loss of a live streaming platform, reducing costs and an operation risk of the live streaming platform, and effectively enhancing a management to the users and a security of the live streaming platform.

Embodiments of the present disclosure also provide a terminal.

Embodiments of the present disclosure also provide a storage medium.

Embodiments of the present disclosure propose a method for recharging a live streaming account. The method may include: receiving a recharging request sent by a first user, in which the recharging request includes a user identifier and a recharging amount; determining, according to the user identifier, a credit limit corresponding to the first user currently; judging whether the recharging amount is within a range corresponding to the credit limit; when the recharging amount is within the range corresponding to the credit limit, recharging, according to the recharging amount, an account corresponding to the user identifier.

Embodiments of the present disclosure propose a terminal. The terminal may include one or more processors, a memory storing instructions executable by the one or more processors, in which the one or more processors are configured to: receive a recharging request sent by a first user, in which the recharging request includes a user identifier and a recharging amount; determine, according to the user identifier, a credit limit corresponding to the first user currently; judge whether the recharging amount is within a range corresponding to the credit limit; and recharge, according to the recharging amount, an account corresponding to the user identifier when the recharging amount is within the range corresponding to the credit limit.

Embodiments of the present disclosure also propose a storage medium. The storage medium is configured to store executable program codes, in which the executable program code is configured to perform the method for recharging the live streaming account according to embodiments of the present disclosure.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

In order to clearly illustrate embodiments of the present disclosure and technical solutions in the prior art, a brief description of drawings used in the embodiments or the prior art is given below. Obviously, the drawings in the following descriptions are merely a part of embodiments of the present disclosure, and for those skilled in the art, other drawings may be obtained according to these drawings without creative labor.

FIG. 1 is a flow chart of a method for recharging a live streaming account according to an embodiment of the present disclosure.

FIG. 2 is a flow chart of a method for recharging a live streaming account according to another embodiment of the present disclosure.

FIG. 3 is a block diagram of an apparatus for recharging a live streaming account according to an embodiment of the present disclosure.

FIG. 4 is a block diagram of an apparatus for recharging a live streaming account according to another embodiment of the present disclosure.

FIG. 5 is a block diagram of a terminal according to an embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. Embodiments described herein with reference to drawings are explanatory, serve to explain the present disclosure, and are not construed to limit embodiments of the present disclosure. Instead, embodiments of the present disclosure include all changes, modifications and equivalents falling within the scope of the spirit and meaning of the claims.

Specifically, for methods for recharging the live steaming account in the prior art, there are some problems, including that after an anchor withdraws cash, the live streaming platform still needs to refund the money to the user; some users perform a maliciously recharging and then cancelling the recharging; or some users use the live streaming platform to launder money or cash out, which will greatly increase the costs and risks of the live broadcast platform. Therefore, a method for recharging a live streaming account is provided, in which a credit limit of a user may be determined according to attribute information of the user so as to perform the recharging for the user, and the credit limit of the user may be adjusted dynamically.

The method and apparatus for recharging a live streaming account, and the terminal according to embodiments of the present disclosure will be described below with reference to the accompanying drawings.

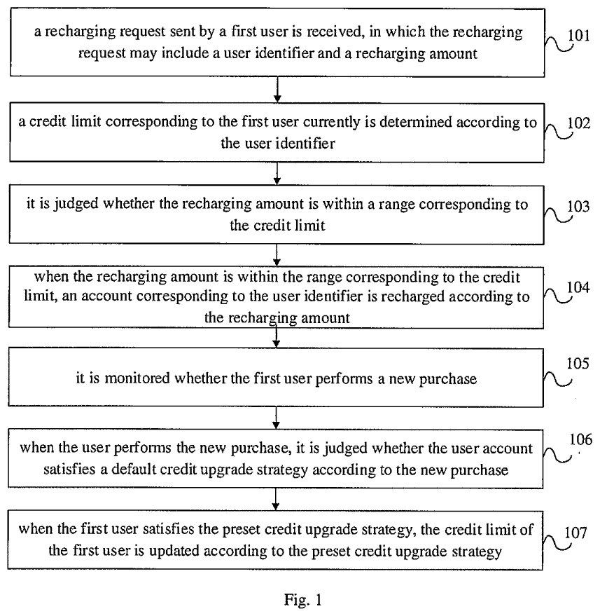

FIG. 1 is a flow chart of a method for recharging a live streaming account according to an embodiment of the present disclosure.

As illustrated in FIG. 1, the method for recharging the live streaming account may include followings.

At block 101, a recharging request sent by a first user is received, in which the recharging request may include a user identifier and a recharging amount.

Specifically, the method provided by embodiments of the present disclosure may be configured in any live streaming platform, so as to manage a recharging operation of the user, thus reducing the operation risks of the live streaming platform and improving the effective management for the users.

The user identifier is used to uniquely identify the user. For example, the user identifier may be an ID (Identity, Identity number), an IP Address (Internet Protocol Address) of the user, and the like.

The recharging amount may have a unit of RMB, USD or EURO, etc.

The recharging request, may be triggered by clicking, sliding or long pressing a button with a recharging function in the live streaming platform by the user, which is not limited herein.

At block 102, a credit limit corresponding to the first user currently is determined according to the user identifier.

The credit limit is used to represent a maximum amount of money that a user is allowed to recharge.

Specifically, when a user needs to recharge, he/she may click the button with the recharging function in the live streaming platform. After the live streaming platform receives the recharging request sent by the user and obtains the user identifier and the recharging amount of the user, the attribute information of the user may be determined according to the user identifier, and then the current credit limit corresponding to the user may be determined according to the attribute information of the user.

The attribute information of the user includes at least one of the following information: a registration time, a recharging frequency, an account balance, a country of the user, an attribute of a device used by the user and a historical consumption behavior.

In a specific implementation, a mapping relationship between the attribute information of the user and the current credit limit corresponding to the user may be set in advance. For example, if the user's registration time is short, there may be no history record of recharging or consumption of the user in the live streaming platform. Therefore, the user's credit cannot be judged. At this time, a low credit limit may be set for the user in advance, such as 50 RMB. If the user has been registered for a long time, and the recharging frequency is relatively high or the account balance is relatively large, in order to avoid risks, a low credit limit may be set for the user in advance, such as 50 yuan RMB. If the country of the user has a good credit or the device used by the user is a high-end product, a high credit limit may be set for the user in advance, such as 100 RMB. If the user's historical consumption behavior is normal, a high credit limit may be set for the user in advance, such as 100 RMB, and the like. Then, after determining the attribute information of the user according to the user identifier, the current credit limit corresponding to the user may be determined according to the mapping relationship between the attribute information of the user and the current credit limit corresponding to the user.

Accordingly, the above act in the block 102 may include followings.

At block 102a, the registration time of the first user is determined according to the user identifier.

At block 102b, it is judged whether the registration time is greater than a first preset value. At block 102c, when the registration time is less than or equal to the first preset value, the credit limit corresponding to the first user currently is determined according to the country of the first user and the attribute of the device used by the first user.

The first preset value may be set as needed, so as to determine whether the user sending the recharging request is a new user. For example, the first preset value may be set to 24 hours, 48 hours, and the like.

Specifically, if the user's registration time determined according to the user identifier is less than or equal to the first preset value, it means that the user's registration time is relatively short and the user is a new user, the user's credit record of recharging or consumption may not be contained in the live broadcast platform. Thus, the current credit limit corresponding to the user may be determined according to a credit record of another user with a country same as the country of the user and with an attribute of a device same as the attribute of the device used by the user.

For example, it is assumed that the first preset value is 24 hours, if the user's registration time determined according to the user identifier is 10 hours which is less than the first preset value, and the country of the user is China, the device being used is iPhone 7, since the credit limit of other users from China and using iPhone 7 is 100 RMB, the credit limit of the user may be determined as 100 RMB.

In addition, it can be understood that, if the user's registration time is greater than the first preset value, it means that the registration time of the user is relatively long, and there may be the user's credit record of recharging or consumption in the live streaming platform. At this time, the current credit limit corresponding to the user may be determined according to at least one of the recharging frequency, the account balance and the historical consumption behavior of the user.

For example, it is assumed that the first preset value is 24 hours, when the historical consumption behavior of a non-new user is well recorded, the credit limit corresponding to the user is set as 500 RMB in advance. If the registration time of the user determined according to the user identifier is one month which is greater than the first preset value, and the user has a good record of historical consumption behavior, then the current credit limit corresponding to the user may be determined as 500 RMB.

At block 103, it is judged whether the recharging amount is within a range corresponding to the credit limit.

At block 104, when the recharging amount is within the range corresponding to the credit limit, an account corresponding to the user identifier is recharged according to the recharging amount.

In specific implementations, after determining the current credit limit corresponding to the user, if the recharging amount in the recharging request sent by the user is within the credit limit range, the live streaming platform may recharge the account of the user according to the recharging amount. If the recharging amount in the recharging request sent by the user is not within the credit limit range, the live streaming platform may return a recharging failure message to the user; or, the live streaming platform may return a prompt message of modifying the recharging amount to the user, in which the prompt message includes the current credit limit corresponding to the user.

For example, it is assumed that the current credit limit corresponding to the user is 100 RMB, the recharging amount in the recharging request sent by the user is 200 RMB which is not within the credit limit range, then the live streaming platform may return a prompt message of “your credit limit is 100 RMB, please recharge within the credit limit” to the user to prompt the user to modify the recharging amount.

It can be understood that, a new consumption behavior may be caused after the user performs the recharging this time. In embodiments of the present disclosure, the user's credit limit may be updated timely according to the new consumption behavior. In other words, the method may include followings after the act in block 104.

At block 105, it is monitored whether the first user performs a new purchase.

At block 106, when the user performs the new purchase, it is judged whether the user account satisfies a default credit upgrade strategy according to the new purchase.

At block 107, when the first user satisfies the preset credit upgrade strategy, the credit limit of the first user is updated according to the preset credit upgrade strategy.

The preset credit upgrade strategy may include a credit upgrade condition, and a credit upgrade amount, and the like.

For example, the credit limit may be increased to 120% of the current credit limit corresponding to the user when the user's new consumption behavior is normal. After recharging, the user may present gifts to multiple anchors, present gifts to high-quality anchors on the live streaming platform or present gifts to anchors who continue to broadcast. These behaviors may be regarded as normal new consumption behaviors.

Specifically, after it is determined that the first user satisfies the preset credit upgrade strategy according to the new purchasing behavior of the user, the credit limit of the user may be updated according to the preset credit upgrade strategy. For example, it is assumed that the current credit limit corresponding to the user is 100 RMB, and the preset credit upgrade strategy is to increase the credit limit to 120% of the current credit limit corresponding to the user when the user's new consumption behavior is normal. If the user presents gifts to multiple anchors after recharging, the credit limit of the user may be updated to 120 RMB according to the preset credit upgrade strategy.

By updating the user's credit limit in time according to the user's consumption behavior, the delay that may be caused when the user's current credit limit is determined according to the user identifier after receiving the user's recharging request may be avoided.

With the method for recharging the live streaming account according to embodiments of the present disclosure, a recharging request sent by a first user is firstly received, in which the recharging request may include a user identifier and a recharging amount. After that, a credit limit corresponding to the first user currently may be determined according to the user identifier. Finally, when the recharging amount is within a range corresponding to the credit limit, an account corresponding to the user identifier may be recharged according to the recharging amount. Thus, the method may realize a determination of the credit limit of the user according to the attribute information of the user so as to perform the recharging for the user. In addition, the credit limit of the user may be adjusted dynamically, thereby reducing a loss of a live streaming platform, reducing costs and an operation risk of the live streaming platform, and effectively enhancing a management to the users and a security of the live streaming platform.

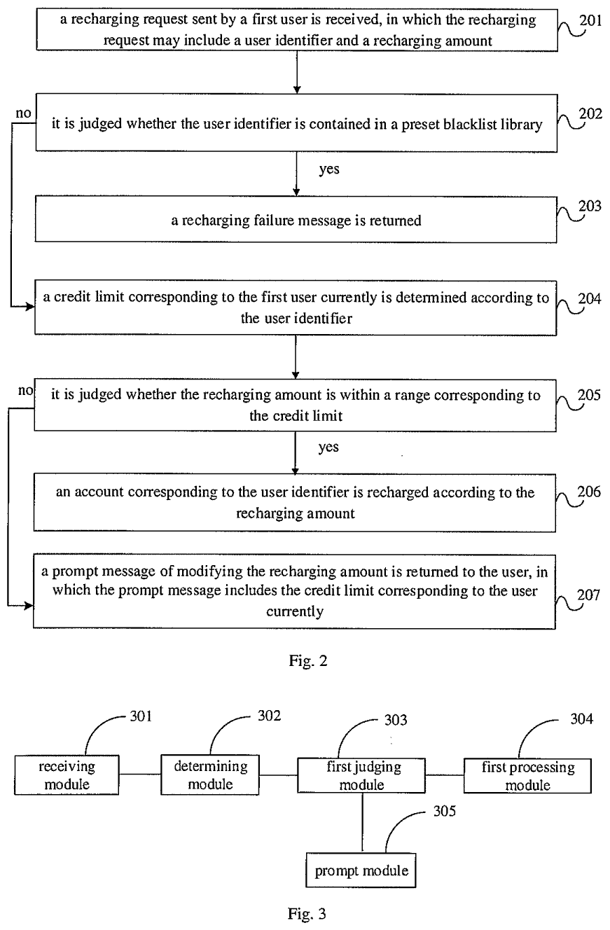

According to the above analysis, after receiving the recharging request sent by the user, the current credit limit corresponding to the user may be determined according to the user identifier, and the account corresponding to the user identifier may be recharged when the recharging amount is within the credit limit range. In a possible implementation of the present disclosure, it may be quickly determined whether to recharge for the user's account according to a preset blacklist library, which will be described in detail with reference to FIG. 2.

FIG. 2 is a flow chart of a method for recharging a live streaming account according to another embodiment of the present disclosure.

As illustrated in FIG. 2, the method may include followings.

At block 201, a recharging request sent by a first user is received, in which the recharging request may include a user identifier and a recharging amount.

At block 202, it is judged whether the user identifier is contained in a preset blacklist library, if yes, act in block 203 is performed, if no, act in block 204 is performed.

At block 203, a recharging failure message is returned.

The preset blacklist library includes a record of an abnormal behavior. For example, a high number of the user's historical refund requests, the user merely presenting gifts to a designated low-quality anchor after recharging, or presenting gifts to an anchor who hasn't started broadcasting, and the like, may all be considered as the user's abnormal consumption behaviors.

In a specific implementation, after receiving the recharge request sent by the user, if it is determined that the user identifier is contained in the preset blacklist library, it may be determined that the user has an abnormal consumption behavior, which may cause a loss to the live broadcasting platform. At this time, a recharge failure message may be returned to the user.

Accordingly, in embodiments of the present disclosure, the user identifier of the user with an abnormal consumption behavior may be added to the blacklist library. That is, before act in block 202 is performed, it may be judged whether the user's consumption behavior is abnormal in advance, if yes, the user identifier may be added to the blacklist library.

Specifically, whether the user's consumption behavior is abnormal may be judged from many aspects.

For example, it may be judged whether a number of the user's historical refund requests is greater than a first preset value. The first preset value may be determined according to the user's registration time and the number of historical refund requests of most users with the same registration time. For example, the first preset value may be set to 5 or 8, and the like.

In a specific implementation, it is assumed that the first preset value is 5, if the number of the user's historical refund requests is 6 which is greater than the first preset value, the user's consumption behavior may be judged to be abnormal, and the user may conduct a malicious refunding, such that the user identifier may be added to the blacklist library.

Alternatively, it may be judged whether an anchor rewarded by the user meets a preset condition. The preset condition is used to indicate whether the anchor is a high-quality anchor. Specifically, it may be judged whether the number of fans of the anchor is large enough, or whether the live broadcasting time of the anchor is long enough, and the like.

In a specific implementation, it may be judged whether the number of fans of the anchor rewarded by the user is greater than a second preset value, or whether a live time of the anchor rewarded by the user (i.e., a time period of the anchor on living) is greater than a third preset value, or whether a number of anchors rewarded by the user is greater than a fourth preset value. The second preset value, the third preset value and the fourth preset value may be set as required. If the judging result is no, it means that the anchor rewarded by the user does not meet the preset condition, and the user may launder money or making purchases or consumption with fraudulent cards by presenting gifts to a low-quality anchor, which may cause a loss to the live broadcasting platform. At this time, the user identifier may be added to the blacklist library.

By adding the user identifier with an abnormal consumption behavior into the blacklist library, it may be quickly determined whether to recharge the account corresponding to the user identifier after receiving the user's recharging request, thereby reducing the loss of the live streaming platform, reducing costs and the operation risk of the live streaming platform, and enhancing the security of the live streaming platform.

Further, a user may be added to the blacklist library due to misoperation. In embodiments of the present disclosure, after returning the recharging failure message, a guiding message of eliminating the abnormal behavior may be returned to the user according to the abnormal behavior record. For example, the user may be suggested to recharge after a period of time, or the user may be requested to provide identity information to authenticate, and the like, so as to eliminate the abnormal behavior. Alternatively, the credit limit corresponding to the user may be reduced to minimize the loss of the live broadcasting platform as much as possible.

The user experience is improved by returning a guiding message of eliminating the abnormal behavior to the user.

At block 204, a credit limit corresponding to the first user currently is determined according to the user identifier.

In a specific implementation, if it is determined that the user identifier is not included in the preset blacklist library after receiving the recharging request sent by the user, it may be determined that there is no abnormal consumption behavior of the user. At this time, the act in block 204 and subsequent acts may be performed.

At block 205, it is judged whether the recharging amount is within a range corresponding to the credit limit, if yes, act in block 206 is performed, if no, act in block 207 is performed.

At block 206, an account corresponding to the user identifier is recharged according to the recharging amount.

At block 207, a prompt message of modifying the recharging amount is returned to the user, in which the prompt message includes the credit limit corresponding to the user currently.

The specific implementation process and principle of acts in blocks 201, 204-207 described above refers to the detailed description of acts in blocks 101-104 in the above embodiments, which will not be described in detail herein.

With the method for recharging the live streaming account according to embodiments of the present disclosure, a recharging request sent by a first user is firstly received, in which the recharging request may include a user identifier and a recharging amount. After that, it is judged whether the user identifier is included in a preset blacklist library, if yes, a recharging failure message is returned; otherwise, a credit limit corresponding to the first user currently is determined according to the user identifier. It is judged whether the recharging amount is within a range corresponding to the credit limit, if yes, an account corresponding to the user identifier is recharged according to the recharging amount; otherwise, a prompt message of modifying the recharging amount is returned to the user. Thus, the method may realize a determination of the credit limit of the user according to the attribute information of the user so as to perform the recharging for the user. In addition, the credit limit of the user may be adjusted dynamically, and it may be quickly determined whether to recharge the user according to a set blacklist library, thereby reducing a loss of a live streaming platform, reducing costs and an operation risk of the live streaming platform, and effectively enhancing a management to the users and a security of the live streaming platform, improving the user experience.

FIG. 3 is a block diagram of an apparatus for recharging a live streaming account according to an embodiment of the present disclosure.

As illustrated in FIG. 3, the apparatus may include a receiving module 301, a determining module 302, a first judging module 303 and a first processing module 304.

The receiving module 301 is configured to receive a recharging request sent by a first user, in which the recharging request includes a user identifier and a recharging amount.

The determining module 302 is configured to determine, according to the user identifier, a credit limit corresponding to the first user currently.

The first judging module 303 is configured to judge whether the recharging amount is within a range corresponding to the credit limit.

The first processing module 304 is configured to recharge, according to the recharging amount, an account corresponding to the user identifier when the recharging amount is within the range corresponding to the credit limit.

The apparatus for recharging the live streaming account provided in this embodiment may be configured in any live streaming platform to manage users' recharge operations, thus reducing the operation risks of the live streaming platform and improving the effective management of users.

In a possible implementation of the embodiment, the determining module 302 is specifically configured to: determine, according to the user identifier, attribute information of the first user; determine, according to the attribute information of the first user, the credit limit corresponding to the first user currently.

The attribute information of the user may include at least one of: a registration time, a recharging frequency, an account balance, a country of the user, an attribute of a device used by the user, and a historical consumption behavior.

Further, the determining module 302 includes: a first determining unit, a first judging unit and a second determining unit.

The first determining unit is configured to determine, according to the user identifier, the registration time of the first user.

The first judging unit is configured to judge whether the registration time is greater than a first preset value.

The second determining unit is configured to determine, according to the country of the first user and the attribute of the device used by the first user, the credit limit corresponding to the first user currently when the registration time is less than or equal to the first preset value.

Further, the second determining unit is specifically configured to: determine, according to a credit record of another user with a country same as the country of the user and with an attribute of a device same as the attribute of the device used by the user, the credit limit corresponding to the first user currently.

In another possible implementation of the embodiment, the determining module 302 may also include a third determining unit.

The third determining unit is configured to determine, according to at least one of the recharging frequency, the account balance and the historical consumption behavior of the first user, the credit limit corresponding to the user currently when the registration time is greater than the first preset value.

In another possible implementation of the embodiment, the apparatus may also include a prompt module 305.

The prompt module 305 is configured to return a prompt message of modifying the recharging amount to the user when the recharging amount is beyond the range of the credit limit, in which the prompt message includes the credit limit corresponding to the first user currently.

It should be noted that the above description of embodiments of the method for recharging the live streaming account is also applicable to the apparatus for recharging the live streaming account provided in this embodiment, which will not be described in detail herein.

With the apparatus for recharging the live streaming account according to embodiments of the present disclosure, a recharging request sent by a first user is firstly received, in which the recharging request may include a user identifier and a recharging amount. After that, a credit limit corresponding to the first user currently may be determined according to the user identifier. Finally, when the recharging amount is within a range corresponding to the credit limit, an account corresponding to the user identifier may be recharged according to the recharging amount. Thus, the apparatus may realize a determination of the credit limit of the user according to the attribute information of the user so as to perform the recharging for the user. In addition, the credit limit of the user may be adjusted dynamically, thereby reducing a loss of a live streaming platform, reducing costs and an operation risk of the live streaming platform, and effectively enhancing a management to the users and a security of the live streaming platform.

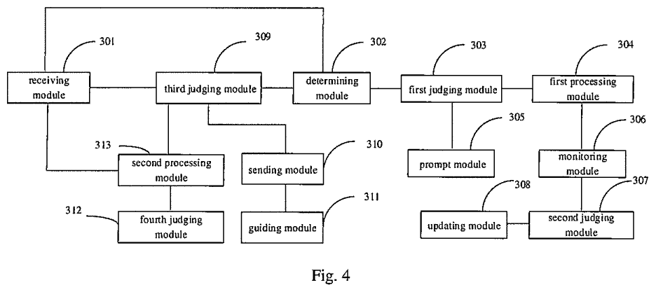

FIG. 4 is a block diagram of an apparatus for recharging a live streaming account according to another embodiment of the present disclosure.

As illustrated in FIG. 4, based on FIG. 3, the apparatus may also include a monitoring module 306, a second judging module 307 and an updating module 308.

The monitoring module 306 is configured to monitor whether the first user performs a new purchase.

The second judging module 307 is configured to judge, according to the new purchase, whether the first user satisfies a preset credit upgrade strategy when the user performs the new purchase.

The updating module 308 is configured to update, according to the preset credit upgrade strategy, the credit limit of the first user when the first user satisfies the preset credit upgrade strategy.

In a possible implementation of the embodiment, the apparatus may also include a third judging module 309 and a sending module 310.

The third judging module 309 is configured to judge whether the user identifier is contained in a preset blacklist library.

The sending module 310 is configured to return a recharging failure message when the user identifier is contained in the preset blacklist library.

In another possible implementation of the embodiment, the preset blacklist library may include a record of an abnormal behavior.

Accordingly, the apparatus may also include a guiding module 311.

The guiding module 311 is configured to return, according to the record of the abnormal behavior, a guiding message of eliminating the abnormal behavior to the first user.

In another possible implementation of the embodiment, the apparatus may also include a fourth judging module 312 and a second processing module 313.

The fourth judging module 312 is configured to judge whether the consumption behavior of the first user is abnormal.

The second processing module 313 is configured to add the user identifier to the preset blacklist library when the consumption behavior of the first user is abnormal.

Further, the fourth judging module 312 includes: a second judging unit, configured to judge whether a number of historical refund requests of the first user is greater than a first preset value; and/or, a third judging unit, configured to judge whether an anchor rewarded by the first user meets a preset condition.

Further; the third judging unit is specifically configured to: judge whether a number of fans of the anchor rewarded by the first user is greater than a second preset value; and/or, judge whether a live time of the anchor rewarded by the first user is greater than a third preset value; and/or, judge whether a number of anchors rewarded by the first user is greater than a fourth preset value.

It should be noted that the above description of embodiments of the method for recharging the live streaming account is also applicable to the apparatus for recharging the Jive streaming account provided in this embodiment, which will not be described in detail herein.

With the apparatus for recharging the live streaming account according to embodiments of the present disclosure, a recharging request sent by a first user is firstly received, in which the recharging request may include a user identifier and a recharging amount. After that, it is judged whether the user identifier is included in a preset blacklist library, if yes, a recharging failure message is returned; otherwise, a credit limit corresponding to the first user currently is determined according to the user identifier. It is judged whether the recharging amount is within a range corresponding to the credit limit, if yes, an account corresponding to the user identifier is recharged according to the recharging amount; otherwise, a prompt message of modifying the recharging amount is returned to the user. Thus, the apparatus may realize a determination of the credit limit of the user according to the attribute information of the user so as to perform the recharging for the user. In addition, the credit limit of the user may be adjusted dynamically, and it may be quickly determined whether to recharge the user according to a set blacklist library, thereby reducing a loss of a live streaming platform, reducing costs and an operation risk of the live streaming platform, and effectively enhancing a management to the users and a security of the live streaming platform, improving the user experience.

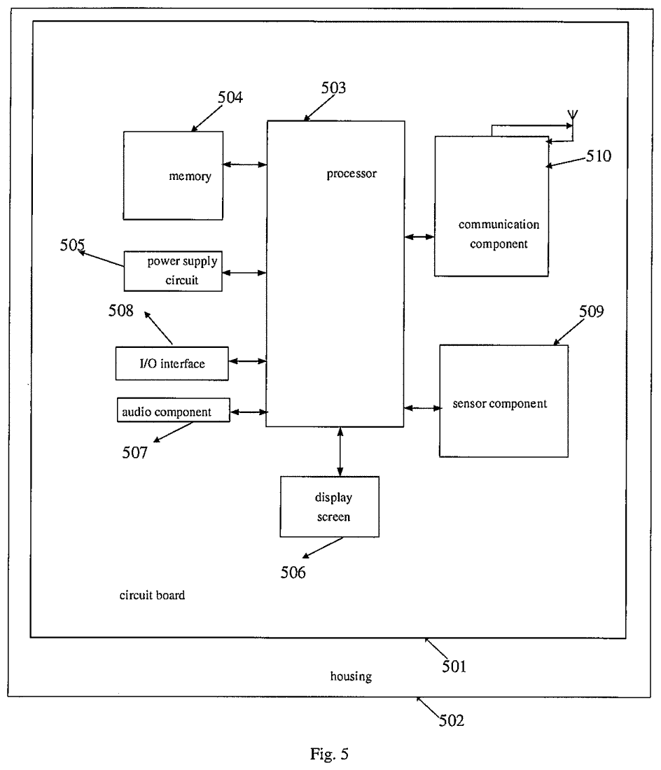

FIG. 5 is a block diagram of a terminal according to an embodiment of the present disclosure.

There are many types of terminals, such as mobile phones, PDAs, laptops and wearable devices, and the like, which is not limited herein.

As illustrated in FIG. 5, the terminal includes one or more of following components: a circuit board 501, a housing 502, a processor 503, a memory 504, a power supply circuit 505, a display screen 506, an audio component 507, an input/output (I/O) interface 508, a sensor component 509, and a communication component 510; in which, the circuit board 501 is enclosed by the housing 502; the processor 503 and the memory 504 are positioned on the circuit board 501; the power supply circuit 505 is configured to provide power for respective circuits or components of the terminal; the memory 504 is configured to store executable program codes; the processor 503 is configured to run a program corresponding to the executable program codes by reading the executable program codes stored in the memory 504, such that the processor 503 is caused to perform the method for recharging the live streaming account described in the first aspect.

It should be noted that, the above explanation of embodiments of the method for charging the live streaming account is also applicable to the terminal of the embodiment, and the implementation principles are similar, which will not be elaborated in detail herein.

With the terminal according to embodiments of the present disclosure, a recharging request sent by a first user is firstly received, in which the recharging request may include a user identifier and a recharging amount. After that, a credit limit corresponding to the first user currently may be determined according to the user identifier. Finally, when the recharging amount is within a range corresponding to the credit limit, an account corresponding to the user identifier may be recharged according to the recharging amount. Thus, the terminal may realize a determination of the credit limit of the user according to the attribute information of the user so as to perform the recharging for the user. In addition, the credit limit of the user may be adjusted dynamically, thereby reducing a loss of a live streaming platform, reducing costs and an operation risk of the live streaming platform, and effectively enhancing a management to the users and a security of the live streaming platform. According to the method for recharging the live streaming account provided in embodiments described above, another aspect of the present disclosure provides a storage medium, configured to store executable program codes.

When the executable program codes are executed, the method for recharging the live streaming account of embodiments of the present disclosure may be realized.

Further, yet another aspect of the present disclosure provides an executable program code, configured to implement the method for recharging the live streaming account of embodiments of the present disclosure.

Terms throughout this specification to “an embodiment”, “some embodiments”, “an example”, “a specific example”, or “some examples” mean that a particular feature, structure, material, or characteristic described in connection with the embodiment or example is included in at least one embodiment or example of the present disclosure. The appearances of the above terms in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or significance. Thus, the feature defined with “first” and “second” may include one or more this feature. In the description of the present disclosure, “a plurality of” means at least two, for example, two or three, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which the functions may be performed in an order which differs from the depicted order, such as a simultaneous order or an operate order according to the related functions, which should be understood by those skilled in the art.

It should be understood that each part of the present disclosure may be realized by hardware, software, firmware or a combination thereof. In the above embodiments, a plurality of steps or methods may be realized by software or firmware stored in the memory and executed by an appropriate instruction execution system. For example, if it is realized by the hardware, likewise in another embodiment, it may be realized by one or a combination of the following techniques known in the art: a discrete logic circuit having a logic gate circuit for realizing a logic function for a data signal, an application-specific integrated circuit having an appropriate combination logic gate circuit, a programmable gate array (PGA), a field programmable gate array (FFGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

The storage medium mentioned above may be read-only memories, magnetic disks or CD, etc. Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

1. A method for recharging a live streaming account, comprising:
receiving a recharging request sent by a first user, wherein the recharging request comprises a user identifier and a recharging amount;
determining, according to the user identifier, a credit limit corresponding to the first user currently;
judging whether the recharging amount is within a range corresponding to the credit limit; and
when the recharging amount is within the range corresponding to the credit limit, recharging, according to the recharging amount, an account corresponding to the user identifier.

2. The method according to claim 1, wherein determining, according to the user identifier, the credit limit corresponding to the first user currently comprises:
determining, according to the user identifier, attribute information of the first user; and
determining, according to the attribute information of the first user, the credit limit corresponding to the first user currently.

3. The method according to claim 2, wherein the attribute information of the first user comprises at least one of: a registration time, a recharging frequency an account balance, a country of the first user, an attribute of a device used by the first user, and a historical consumption behavior.

4. The method according to claim 3, wherein determining, according to the user identifier, the credit limit corresponding to the first user currently comprises:
determining, according to the user identifier, the registration time of the first user;
judging whether the registration time is greater than a first preset value; and
when the registration time is less than or equal to the first preset value, determining, according to the country of the first user and the attribute of the device used by the first user, the credit limit corresponding to the first user currently.

5. The method according to claim 4, wherein determining, according to the country of the first user and, the attribute of the device used by the first user, the credit limit corresponding to the user currently comprises:
determining, according to a credit record of a second user with a country same as the country of the first user and with an attribute of a device same as the attribute of the device used by the first user, the credit limit corresponding to the first user currently.

6. The method according to claim 4, wherein, after judging whether the registration time is greater than the first preset value, the method further comprises:
when the registration time is greater than the first preset value, determining, according to at least one of the recharging frequency, the account balance and the historical consumption behavior of the first user, the credit limit corresponding to the user currently.

7. The method according to claim 1, wherein, after judging whether the recharging amount is within the range corresponding to the credit limit, the method further comprises:
when the recharging amount is beyond the range corresponding to the credit limit, returning, a prompt message of modifying the recharging amount to the user, the prompt message comprising the credit limit corresponding to the user currently.

8. The method according to claim 1, wherein, after recharging, according to the recharging amount, the account corresponding to the user identifier, the method further comprises:
monitoring whether the first user performs a new purchase;
when the user performs the new purchase, judging, according to the new purchase, whether the first user satisfies a preset credit upgrade strategy; and
when the first user satisfies the preset credit upgrade strategy, updating, according to the preset credit upgrade strategy, the credit limit of the first user.

9. The method according to claim 1, wherein, after receiving the recharging request sent by the first user, the method further comprises:
judging whether the user identifier is contained in a preset blacklist library; and
when the user identifier is contained in the preset blacklist library, returning a recharging failure message.

10. The method according to claim 9, wherein, the preset blacklist library comprises a record of an, abnormal behavior; and
after returning the recharging failure message, the method further comprises:
returning, according to the record of the abnormal behavior, a guiding message of eliminating the abnormal behavior to the first user.

11. The method according to claim 9, wherein, before judging whether the user identifier is contained in the preset blacklist library, the method further comprises:
judging whether the consumption behavior of the first user is abnormal; and
when the consumption behavior of the first user is abnormal adding the user identifier to the preset blacklist library.

12. The method according to claim 11, wherein judging whether the consumption behavior of the user is abnormal comprises at least one act of:
judging whether a number of historical refund requests of the first user s greater than a first preset value;
and
judging whether an anchor rewarded by the first user meets a preset condition.

13. The method according to claim 12, wherein judging whether the anchor rewarded by the first user meets the preset condition comprises at least one act of;
judging whether a number of fans of the anchor rewarded by the first user is greater than a second preset value;
and
judging whether a live time of the anchor rewarded by the first user is greater than a third preset value;
and
judging whether a number of anchors rewarded by the first user is greater than a fourth preset value.

14. A terminal, comprising: one or more processors, a memory storing instructions executable lad the one or more processors, wherein the one, or more processors are configured to:
receive a recharging request sent by a first user, wherein the recharging request comprises a user identifier and a recharging amount;
determine, according to the user identifier, a credit limit corresponding to the first, user currently;
judge whether the recharging amount is within a range corresponding to the credit omit; and
recharge, according to the recharging amount, an account corresponding to the user identifier when the recharging amount is within the range corresponding to the credit limit.

15. The terminal according to claim 14, wherein the one or more processors determine, according to the user identifier, the credit limit corresponding to the first user currently by performing acts of:
determining, according to the user identifier, attribute information of the first user; and
determining, according to the attribute information of the first user, the credit limit corresponding to the first user currently.

16. The terminal according to claim 15, wherein the attribute information of the first user comprises at least one of: a registration time, a recharging frequency, an account balance, a country of the first user, an attribute of a device used by the first user, and a historical consumption behavior.

17. The apparatus-terminal according to claim 16, wherein the one or more processors determine, according to the user identifier, the credit limit corresponding to the first user currently by performing acts of:
determining, according to the user identifier, the registration time of the first user;
judging whether the registration time is greater than a first preset value; and
determining, according to the country of the first user and the attribute of the device used by the first user, the credit limit corresponding to the first user currently when the registration time is less than or equal to the first preset value.

18. The terminal according to claim 17, wherein the one or more processors determine, according to the country of the first user and the attribute of the device used by the first user, the credit limit corresponding to the user currently by performing an act of:
determining, according to a credit record of a second user with a country same as the country of the first user and with an attribute of a device same as the attribute of the device used by the first user, the credit limit corresponding to the first user currently.

19. The terminal according to claim 17, wherein the one or more processors are further configured to:
determine, according to at least one of the recharging frequency, the account balance and the historical consumption behavior of the first user, the credit limit corresponding to the first user currently when the registration time is greater than the first preset value.

20. The terminal according to claim 14, wherein the one or more processors are further configured to:
return a prompt message of modifying the recharging amount to the user when the recharging amount is beyond the range of the credit limit, wherein the prompt message comprises the credit limit corresponding to the first user currently.

21. The terminal according to claim 14, further wherein the one or more processors are further configured to:
monitor whether the first user performs a new purchase;
judge, according to the new purchase, whether the first user satisfies a preset credit upgrade strategy when the user performs the new purchase; and
update, according to the preset credit upgrade strategy, the credit limit of the first user when the first user satisfies the preset credit upgrade strategy.

22. The terminal according to claim 14, wherein the one or more processors are further configured to:
judge whether the user identifier is contained in a preset blacklist library; and
return a recharging failure message when the user identifier is contained in the preset blacklist library.

23. The terminal according to claim 22, wherein, the preset blacklist library comprises a record of an abnormal behavior; and
the one or more processors are further configured to:
return, according to the record of the abnormal behavior, a guiding message of eliminating the abnormal behavior to the first user.

24. The terminal according to claim 22, wherein the one or more processors are further configured to:
judge whether the consumption behavior of the first user is abnormal; and
add the user identifier to the preset blacklist library when the consumption behavior of the first user is abnormal.

25. The terminal according to claim 24, wherein the one or more processors judge whether the consumption behavior of the user is abnormal by performing at least one act of:
judging whether a number of historical refund requests of the first user is greater than a first preset value;
and
judging whether an anchor rewarded by the first user meets a preset condition.

26. The terminal according to claim 25, wherein the one or more processors judge whether the anchor rewarded by the first user meets the preset condition by performing at least one act of:
judging whether a number of fans of the anchor rewarded by the first user is greater than a second preset value;
and
judging whether a live time of the anchor rewarded by the first user is greater than a third preset value;
and
judging whether a number of anchors rewarded by the first user is g eater than a fourth preset value.

27. (canceled)

28. A storage medium, configured to store an executable program code, wherein the executable program code is configured to perform a method for recharging a live streaming account, and the method comprises:
receiving a recharging request sent by a first user, in which the recharging request comprises a user identifier and a recharging amount:
determining, according to the user identifier, a credit limit corresponding to the first user currently;
judging whether the recharging amount is within a range corresponding to the credit limit; and
when the recharging amount is within the range corresponding to the credit limit, recharging, according to the recharging amount, an account corresponding to the user identifier.

29. (canceled)
